(19) United States
(12) Patent Application Publication
(10) Pub. No.: US 2010/0327084 A1
(43) Pub. Date: Dec. 30, 2010

(54) Drip Irrigation Hose

(76) Inventor: Nelson Boice,, JR., Winter Park, FL (US)

Correspondence Address: Matthew G. McKinney;Shuffield, Lowman & Wilson, P.A., 1000 Legion Place, Suite 1700, Orlando, FL, 32801, US

(21) Appl. No.: 12/491,361

(22) Filed: Jun. 25, 2009

(51) Int. Cl. B05B 15/00; B32B 1/08

(52) U.S. Cl. 239/542; 264/171.12

(57) ABSTRACT

A drip irrigation hose and method of forming a drip irrigation hose is disclosed. The method includes selecting a field to be irrigated and determining a flow rate of irrigation water required for the selected field. In addition, the method includes providing a non-porous conduit material, providing at least one porous material, where the composition of the at least one porous material is different than the non-porous conduit material, and forming the drip irrigation hose with the at least one porous material and the non-porous conduit material, where the porous material forms a continuous and longitudinal strip along the length of the drip irrigation hose.

### FIELD OF THE DISCLOSURE

The present disclosure is generally related to a drip irrigation hose with an integrated porous material.

### BACKGROUND

A drip irrigation hose may be described as a type of diffuser. A series of drip irrigation hoses may be placed along crop rows and interconnected by a mainline that provides the source of irrigation water. The mainline, or manifold, is described in general as a pipe that branches into drip irrigation hoses to provide the irrigation water. The flow distribution by a drip irrigation hose to a crop row may be through the use of ports or orifices in the drip irrigation hose. The hydraulic head along the length of each drip irrigation hose will decrease due to friction losses, elevational changes and/or momentum changes as the irrigation water is dispersed. The volume of flow from each orifice is also influenced by the magnitude of the flow velocity. Accordingly, the discharge flow from each orifice will be different along the drip irrigation hose when the orifices are all the same size.

The fluid mechanic principles that are employed to represent a discharge from a an orifice are as follows:

q=Ka(2gE)^{0.5}

where K=flow coefficient;

a=cross sectional area of orifice;

E=V²/2g+Δh; and

V=mean velocity in drip irrigation hose.

Δh=[(pₘ/γ)+zₘ]−[(p₀/γ)+zₒ], and m and o are subscripts that refer to conditions inside and outside the drip irrigation hose, respectively, at the section where the orifice is located.

The orifices are spaced at intervals along the drip irrigation hose and a change in hydraulic head will occur between orifices due to the head losses in the hose. The head losses can be represented as follows:

h_{f}=f(L/D) (V²/2g)

where L=orifice spacing;

D=diameter of manifold; and

V=mean velocity in the manifold.

To obtain a uniform discharge through each orifice, an iterative process is used to calculate the total required head and assumes that the diameter of the hose, orifice size, and spacing between orifices is uniform. There are many prior art irrigations systems that rely on drip irrigation hoses with uniformly spaced orifices and diameter of orifices.

However, a shortcoming of the prior art includes orifices that may discharge at an unacceptable high orifice velocity because the orifice diameter is relatively small causing a squirting effect that may lead to unwanted erosion. The prior art has used various forms of a tortured flow path at the location of the orifice to reduce the orifice velocity. A tortured flow path is a flow path that winds back and forth several times at the orifice location prior to discharge to increase friction and reduce the orifice velocity. At least one shortcoming of that design is the complexity and expense of the manufacturing process to fabricate the tortured path orifice. Accordingly, there is a need for a simpler means and method of reducing orifice velocity of a drip irrigation hose.

Another shortcoming is the inability of the prior art to adapt to variable field conditions and flow requirements without increasing the length of conduit and thereby increasing costs and waste. Accordingly, there is a need in the relevant art for an irrigation system that has the ability to address variable field conditions due to changes in topography or changing flow requirements for a particular type of crop in a more cost effective and efficient manner. All existing irrigation systems of this type that use irrigation conduits with orifices have the orifices pre-made in the hose before the installation process in the field.

Another shortcoming of the prior art includes that an inventory of various irrigation conduits with pre-made orifices must be maintained to address variable topography of a field. This increases the overall costs for the irrigation system. Further, prior art irrigation conduits are typically pre-manufactured for a specific location in the field. Therefore, if the designated irrigation conduit is installed at the incorrect location, the irrigation system will not function properly. In addition, the prior art systems use a higher than needed water pressure and waste energy. Accordingly, there is a need in the relevant art for an irrigation system that is efficient and reduces installation error that can lead to the irrigation system not functioning properly.

It is, therefore, to the effective resolution of the aforementioned problems and shortcomings of the prior art that the present invention is directed.

However, in view of the prior art at the time the present invention was made, it was not obvious to those of ordinary skill in the pertinent art how the identified needs could be fulfilled.

### SUMMARY

In a particular embodiment, a method of forming a drip irrigation hose is disclosed. The method includes selecting a field to be irrigated and determining a flow rate of irrigation water required for the selected field. In addition, the method includes providing a non-porous conduit material, providing at least one porous material, where the composition of the at least one porous material is different than the non-porous conduit material, and forming the drip irrigation hose with the at least one porous material and the non-porous conduit material, where the porous material forms a continuous and longitudinal strip along the length of the drip irrigation hose.

In another particular embodiment, a method of forming a drip irrigation hose includes selecting a field to be irrigated, determining a flow rate of irrigation water required for the selected field, providing a non-porous conduit material and providing at least one porous material, where the composition of the at least one porous material is different than the non-porous conduit material. The method also includes calculating a diameter required for each orifice in the non-porous conduit that would provide the required volume of the irrigation water at each particular location in the field, making a plurality of orifices in the non-porous conduit of the calculated diameter, and forming the drip irrigation hose with the at least one porous material and the non-porous conduit material. In addition, the method may include the porous material overlaying the plurality of orifices to reduce a velocity of the irrigation water exiting the hose through each orifice.

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

FIG. 1 is a diagram of a particular illustrative embodiment of a drip irrigation hose;

FIG. 2 is a diagram of a cross section of the drip irrigation hose shown in FIG. 1;

FIG. 3 is a diagram of another particular embodiment of a drip irrigation hose with orifices;

FIG. 4 is a diagram of a cross section of the drip irrigation hose shown in FIG. 3;

FIG. 5 is a diagram of a cross section of the drip irrigation hose with orifices and a non-porous material encircling the drip irrigation hose;

FIG. 6 is a schematic diagram of a machine to form the drip irrigation hose shown in FIGS. 1-5;

FIG. 7 is a schematic diagram of the drip irrigation hose installed in a field;

FIG. 8 is a flow diagram of a particular illustrative embodiment of a method of forming the drip irrigation hose shown in FIGS. 1-2; and

FIG. 9 is a flow diagram of a particular illustrative embodiment of a method of forming the drip irrigation hose shown in FIGS. 3-5.

### DETAILED DESCRIPTION

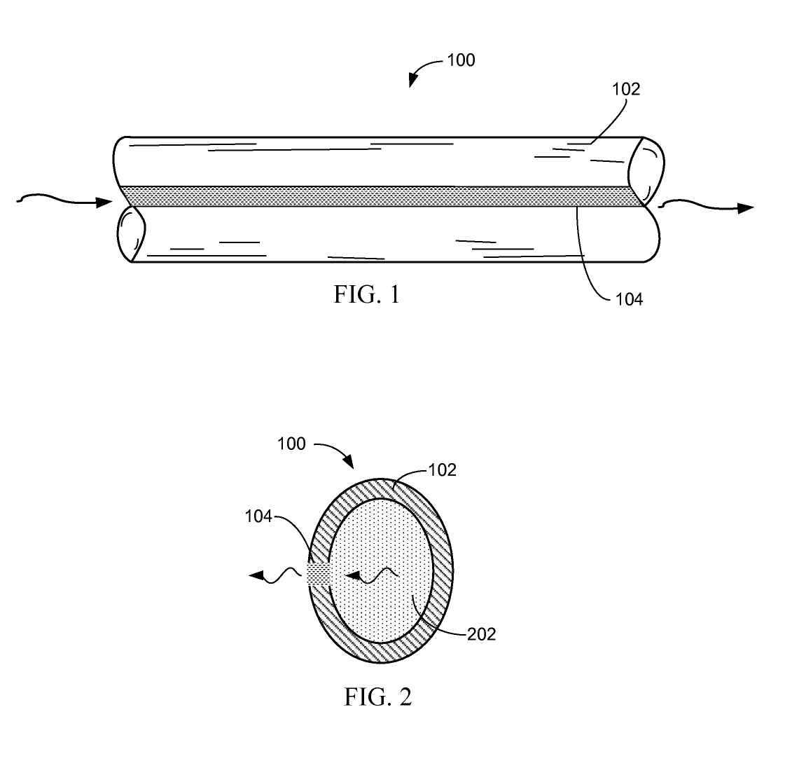

Referring to FIGS. 1 and 2, a particular illustrative embodiment of a drip irrigation hose is disclosed and generally designated 100. As shown therein, the drip irrigation hose 100 includes a non-porous material 102 and a porous material 104. Water flows into the hose 100 and the non-porous material 104 allows water to seep out of the hose 100 to irrigate a field at a desired rate. The porous material 104 may be a continuous longitudinal stripe down the hose 100, where the non-porous material 102 forms most of the conduit 202 for the water to flow. The interior 202 of the hose 100 is illustrated as an oval shape, but could be any number of shapes.

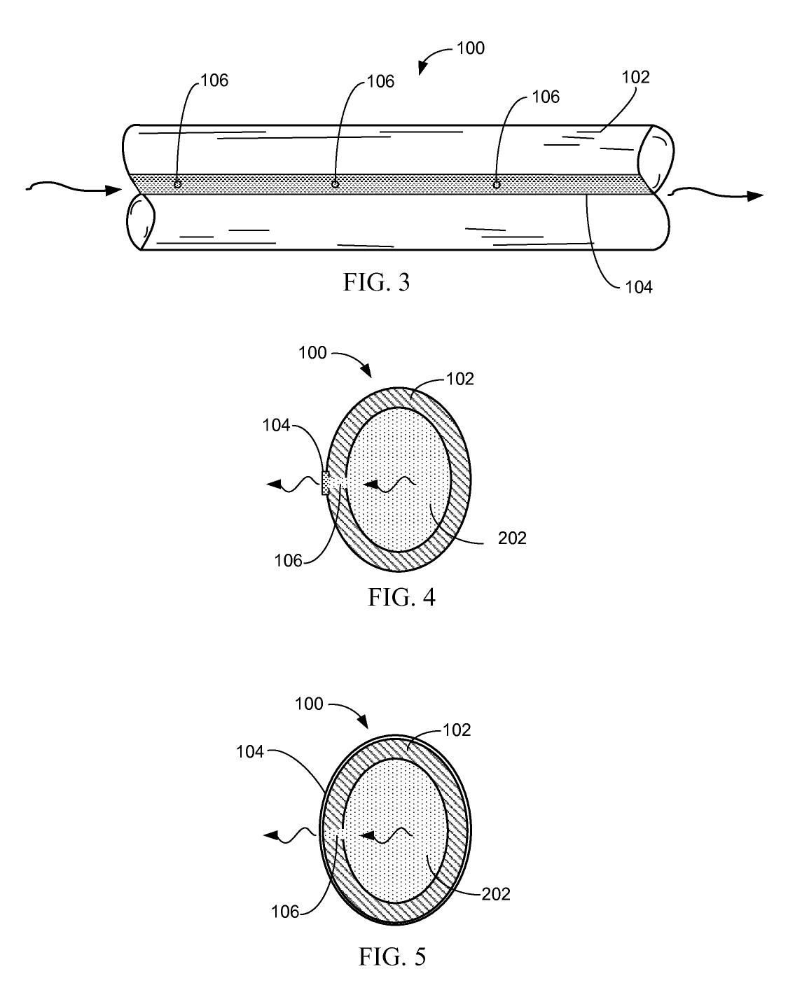

Another particular illustrative embodiment of a drip irrigation hose is shown in FIGS. 3-5. The hose 100 includes a number of orifices 106 that are sized to disperse a desired flow rate. The orifices 106 are relatively small for low flow rates. A disadvantage of the small orifices 106 are clogging and a squirting effect that may lead to unwanted erosion. Thus, a porous material 104 may overlay the orifices 106 to prevent the squirting effect. In addition, the porous material increases the friction losses that the water must overcome to exit the orifice, thereby allowing the orifices to be larger and easier to fabricate than without the porous material 104. The porous material 104 may be a longitudinal strip down the hose 100 as shown in FIGS. 3 and 4. Alternatively, the porous material 104 may completely encircle the hose 100 and non-porous conduit material 102 and orifices 106 as shown in FIG. 5.

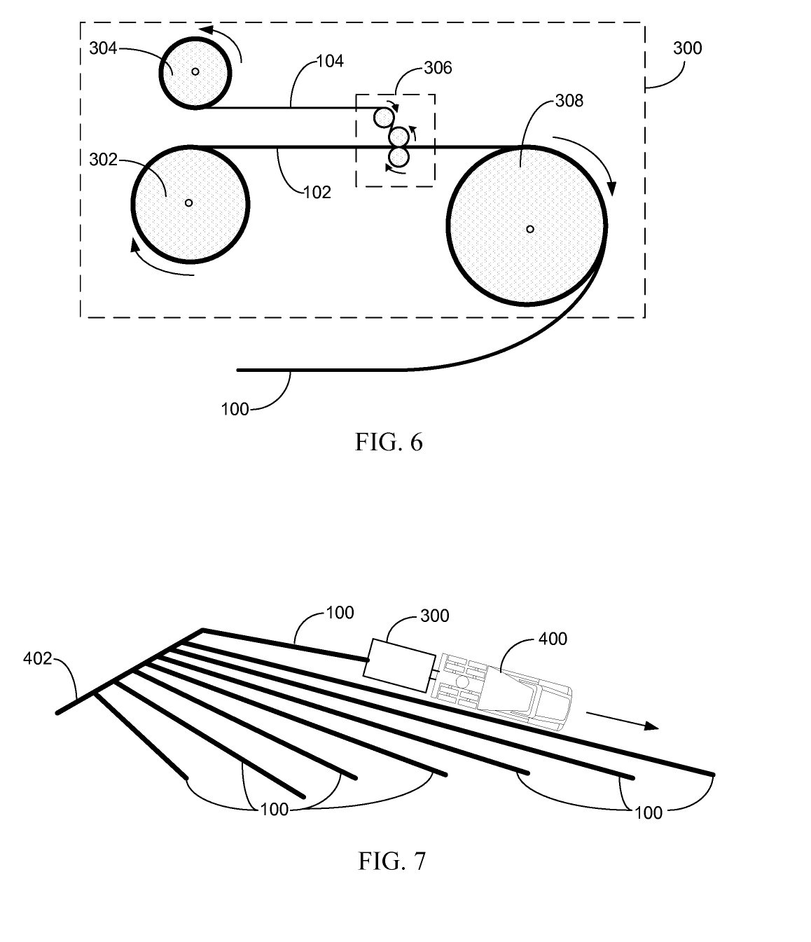

Referring now to FIG. 6, a machine 300 may be used to form the drip irrigation hose in the field. A first spool 302 of non-porous material 102 is configured to allow the non-porous material to be unwound as needed. Similarly, a second spool 304 of porous material 104 is configured to be reeled off at a desired rate. An assembly 306 forms the drip irrigation hose 104. A third spool 308 may be used to store and install the hose 100. A tractor 400 may be used to pull the machine 300 in the field along a crop row to form and install the drip irrigation hose at the desired location, as shown in FIG. 7. A first end of mainline 402 is connected to a water source (not shown). The water source may provide a constant pre-determined hydraulic pressure used to distribute the irrigation water through the drip irrigation hoses 100. In one embodiment of the present invention, an elevated tank is used to create the hydraulic pressure. In an alternative embodiment, a pump is used either independently or in conjunction with the elevated tank to maintain the constant hydraulic pressure. The tractor's 400 specific location and elevation is determined by an on-board GPS system (not shown). A computer-processing unit calculates hydraulic losses in the drip irrigation hoses 100 and may be used to determine the width of the porous material 104 and/or a diameter of an orifice required to deliver a pre-determined volume of water at that specific location where the drip irrigation hose 100 is being installed in the field.

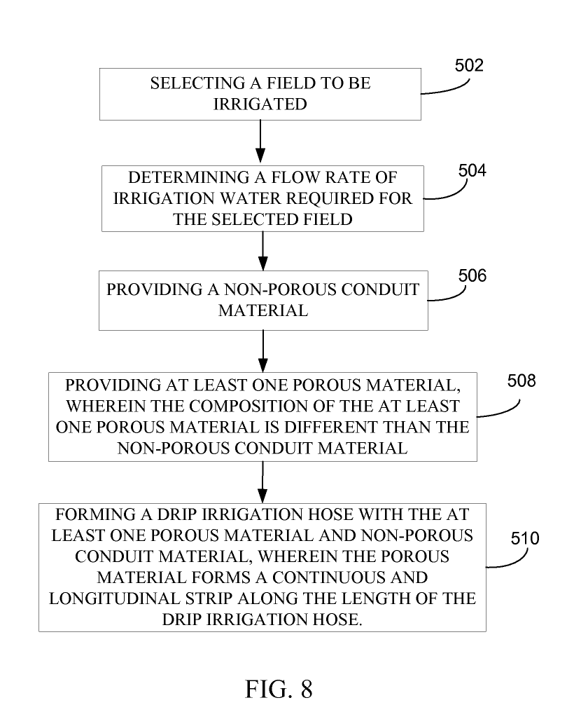

A particular illustrative embodiment of a method of forming a drip hose is illustrated in FIG. 8. At 502, the field to be irrigated is selected. A flow rate of the irrigation water required for the selected field is determined, at 504. For example, the Strawberry Growers Association of Plant City, Fla., states the maximum irrigation required by a mature plants located on 15 inch centers is ⅓ gallon per day. Multiplying the number of plants in the field by this number will provide the amount of the total daily volume of irrigation water needed assuming 3 feet spacing between rows. Accordingly, a one-acre field (208 ft×208 ft) of strawberries requires 3,818 gallons/day. If the desired application is over 24 hours, the required application rate is 2.6 gpm. If the desired application is over 4 hours, the required application rate is calculated as 15.9 gpm.

Moving to 506, a non-porous conduit material is provided and at least one porous material is provided, at 508, where the composition of the at least one porous material is different than the non-porous conduit material. A drip irrigation hose is then formed, at 510, with the at least one porous material and the non-porous conduit material, where the porous material forms a continuous and longitudinal strip along the length of the drip irrigation hose.

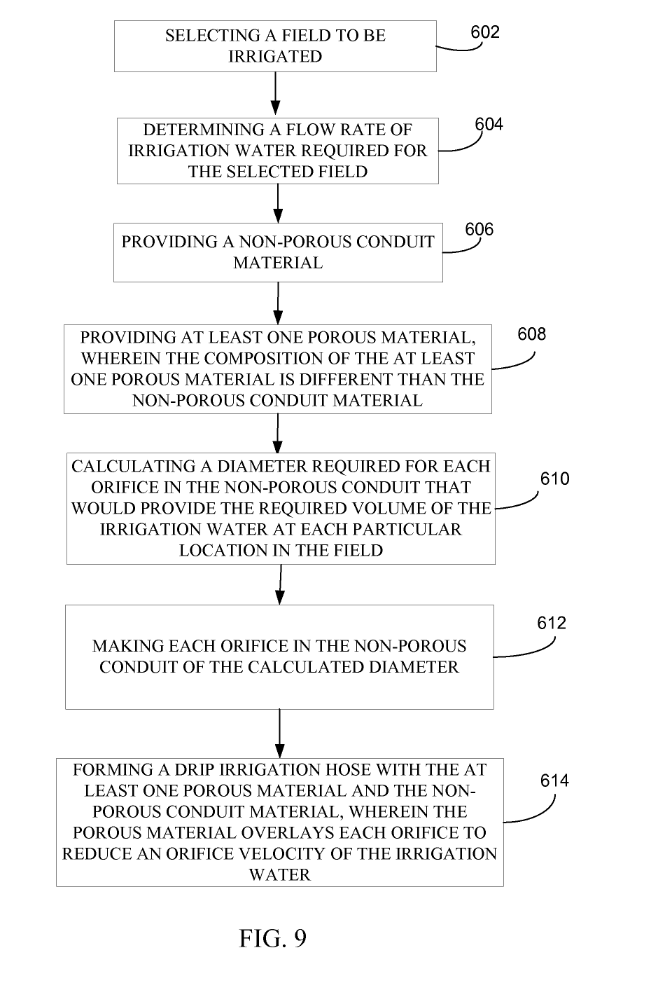

In another particular illustrative embodiment of forming a drip irrigation hose, the field to be irrigated is selected, at 602, as shown in FIG. 9. Continuing to 604, a flow rate of the irrigation water required for the selected field is determined. Moving to 606, a non-porous conduit material is provided and at least one porous material is provided, at 608, where the composition of the at least one porous material is different than the non-porous conduit material. At 610, a required diameter is calculated for each orifice in the non-porous conduit material that would provide the required volume of the irrigation water at each particular location in the field. Each orifice in the non-porous conduit material is then made at 612. A drip irrigation hose is then formed, at 614, with the at least one porous material and the non-porous conduit material, where the porous material overlays each orifice to reduce an orifice velocity of the irrigation water.

Readily understandable diagrams and figures of the present invention described herein illustrate the configurations of the irrigation method and system. The diagrams and figures show those specific details that are pertinent to the present invention so as not to obscure the disclosure with details, which will be readily apparent to those skilled in the art of having the benefit of the description herein. Thus, the diagrams and figures shown in the drawings are primarily intended to show the various components of the invention in convenient functional groupings, so that the present invention may be more readily understood.

Further, the present invention has been described with reference to diagrams and/or flowcharts of methods according to preferred embodiments of the invention. It will be understood that each flowchart illustrating the logic of the present invention can be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create means for implementing the functions specified in the flowchart.

Accordingly, the particular embodiments disclosed above are illustrative only, as the invention may be modified and practiced in different but equivalent manners apparent to those skilled in the art having the benefit of the teachings herein. Furthermore, no limitations are intended to the details of construction or design herein shown. It is therefore evident that the particular embodiments disclosed above may be altered or modified and all such variations are considered within the scope and spirit of the invention.

It is also to be understood that the following claims are intended to cover all of the generic and specific features of the invention herein described, and all statements of the scope of the invention, which as a matter of language, might be said to fall there between.

Now that the invention has been described,

What is claimed is:

1. A method of forming a drip irrigation hose, the method comprising:
selecting a field to be irrigated;
determining a flow rate of irrigation water required for the selected field;
providing a non-porous conduit material;
providing at least one porous material, wherein the composition of the at least one porous material is different than the porous conduit materials; and
forming the drip irrigation hose with the at least one porous material and the non-porous conduit material, wherein the porous material forms a continuous and longitudinal strip along the length of the drip irrigation hose.

2. The method of claim 1, wherein the drip irrigation hose is formed as the hose is installed in the field.

3. The hose of claim 2, wherein the width of the at least one porous material that forms the hose is dependent on a desired irrigation flow rate.

4. A method of forming a drip irrigation hose, the method comprising:
selecting a field to be irrigated;
determining a flow rate of irrigation water required for the selected field;
providing a non-porous conduit material;
providing at least one porous material, wherein the composition of the at least one porous material is different than the non-porous conduit material;
calculating a diameter required for each orifice in the non-porous conduit to provide the required volume of the irrigation water at each particular location in the field;
making a plurality of orifices in the non-porous conduit of the calculated diameter; and
forming the drip irrigation hose with the at least one porous material and the non-porous conduit material.

5. The method of claim 4, wherein the porous material overlays the plurality of orifices to reduce a velocity of the irrigation water exiting the hose through each orifice.

6. The hose of claim 4, wherein the porous material encircles the non-porous material as an outer layer of the hose.

7. The hose of claim 4, wherein the plurality of orifices is made in the non-porous material as the hose is installed in a field.

8. The hose of claim 4, wherein a diameter of each orifice of the plurality of orifices is determined in part by a calculated hydraulic pressure.

9. The method of claim 4, wherein the diameter of each orifice of the plurality of orifices is determined in part by an elevation of a field.

10. The method of claim 4, further comprising providing a source of irrigation water, wherein the irrigation water having a constant pre-determined hydraulic pressure.

11. A drip irrigation hose, the hose comprising:
a non-porous material;
at least one porous material; and
a conduit formed from the non-porous material and the at least one porous material, wherein the conduit is adapted to receive and transport irrigation water therein.

12. The hose of claim 11, further comprising a plurality of orifices in the non-porous material.

13. The hose of claim 11, wherein the amount of the at least one porous material that forms the hose is dependent on a desired irrigation flow rate.

14. The hose of claim 12, wherein the porous material overlays a portion of the non-porous material and the plurality of orifices.

15. The hose of claim 12, wherein the porous material encircles the non-porous material as an outer layer of the hose.

16. The hose of claim 12, wherein the plurality of orifices is made in the non-porous material as the hose is installed in a field.

17. The hose of claim 12, wherein a diameter of each orifice of the plurality of orifices is determined in part by a calculated hydraulic pressure.

18. The hose of claim 12, wherein a laser is used to make the plurality of orifices in the non-porous material.
